(19) United States
(12) Patent Application Publication
(10) Pub. No.: US 2011/0023276 A1
(43) Pub. Date: Feb. 3, 2011

(54) Tool Support with Exchangeable Tool Holders and Tool Holder

(75) Inventor: Karlheinz Jansen, Schutterwald (DE)

Correspondence Address: GUDRUN E. HUCKETT DRAUDT, SCHUBERTSTR. 15A, WUPPERTAL, 42289, DE

(73) Assignee: WTO WERKZEUG-EINRICHTUNGEN GMBH, Ohlsbach (DE)

(21) Appl. No.: 12/848,107

(22) Filed: Jul. 31, 2010

(30) Foreign Application Priority Data
Aug. 3, 2009 (DE) 10 2009 037 167.2

(51) Int. Cl. B23B 7/04

(52) U.S. Cl. 29/40

(57) ABSTRACT

A tool support for a machine tool has a clamping surface. A positioning device for a tool holder is provided that is positioned at the clamping surface. The positioning device has at least one conical element wherein a longitudinal axis of the conical element extends orthogonally to the clamping surface. The conical element is a conical bore or a conical pin. The tool holder is equipped with complementary conical elements so that a positive-locking, precise positioning of the tool holder relative to the receiving bore in the tool support is ensured.

### BACKGROUND OF THE INVENTION

The invention relates to tools support with exchangeable tool holders and a tool holder for such a tool support.

A multitude of tool supports is known in the art that are, for example, in the form of a so-called revolver arranged on a machine tool. These tool supports have at least one clamping surface on which an exchangeable tool holder can be positioned and attached.

A very successful system of tool support and tool holder is the so-called VDI tool holder (VDI=Verein Deutscher Ingenieure; translation: Association of German Engineers) that is standardized in accordance with DIN ISO 10889-1 (DIN=Deutsches Institut für Normung; translation: German Institute for Standardization; ISO=International Organization for Standardization). This tool support is provided with a flat clamping surface in which a receiving bore is provided. Moreover, in the clamping surface a connecting bore for supply of the tool holder with a cooling lubricant may be provided.

The tool holder that is compatible with such a tool support has a contact surface from which a cylindrical shaft projects. The cylindrical shaft is compatible with the receiving bore of the tool support and the contact surface is compatible with clamping surface of the tool support. The cylindrical shaft usually is provided with a toothing that serves for securing the tool holder on the tool support such that the tool holder is able to transmit the forces required for machining a workpiece onto the tool support.

In addition to the simple configuration, the minimal manufacturing costs for the tool support as well as for the interface between the tool support and the tool holder are worth mentioning in particular in connection with the system according to DIN ISO 10889-1.

A disadvantage of this system is however the relatively minimal repeat accuracy for the insertion of the tool holders in one and the same receiving bore. This relatively minimal repeat accuracy has the result that after a tool exchange, for example, because the cutting edge of a cutting chisel is worn, the position of the cutting edge of the tool will change also. In order to ensure despite of this a continuously high manufacturing quality, the deviations in positioning of the tool holder would have to be determined and compensated by the NC control unit of the machine tool. In the first scenario, the precision of the workpiece would suffer. In the second scenario, the manufacturing costs would increase greatly.

This disadvantage of the VDI tool holder has already been known for some time and there are various approaches to overcome this disadvantage.

For example, in this connection DE 10 2005 045 662 A1 should be mentioned. In this system, that is not compatible with the VDI tool holder, the tool revolver comprises two spaced apart and adjustable trapezoidal fitting members in the tool revolver. These fitting members project past the clamping surface and interact with complementarily shaped fitting surfaces of the tool holder and enable in this way an exact positioning of the tool holder relative to the clamping surface of the tool support. The fitting members are connected to a separate plate that at the time of manufacturing the tool revolver is adjusted and subsequently fixed in position so that the fitting members are positioned with the desired precision relative to the receiving bore of the tool support.

A disadvantage of this system is the comparatively high manufacturing expenditure because into the clamping surface a groove must be milled that provides space for the support plate of the fitting members. Subsequently, the fitting members must be aligned relative to the tool revolver and must be secured by pins and/or screwed on in this position. This process requires highly qualified personnel and, despite of this, is still error prone.

A similar system that is also based on trapezoidal fitting members is disclosed in EP 780179 B1. Here, at the end faces of the tool revolver trapezoidal fitting members are formed that interact with complementarily formed recesses in the tool holder. Both systems have in common that they are relatively expensive with respect to manufacturing costs and, moreover, that alignment requires a relatively high amount of labor that must be performed by highly qualified personnel.

DE 203 21 518 U1 discloses moreover that on the edges of the clamping surfaces W-shaped grooves are ground into the clamping surfaces that, together with appropriately shaped grooves of the tool holder, provide a positive-locking connection. In this way, positioning of the tool holder is improved but this is achieved by a considerable manufacturing expenditure. It is thus required to provide by grinding each contact surface and thus the entire periphery of the revolver head with W-shaped grooves. This is very cost-intensive and, furthermore, requires very high precision.

The same holds true also for the tool holders that must have complementary W-shaped profiles that must project past the contact surface of the actual tool holder. In this way, the manufacture of the contact surface is also made more expensive and more difficult.

### SUMMARY OF THE INVENTION

It is an object of the present invention to provide a tool support and a tool holder that is compatible therewith that is of a simple configuration and has a significantly higher positional precision than a conventional VDI tool holder according to DIN ISO 10889-1.

This object is solved according to the present invention in connection with a tool support for a machine tool, in particular a lathe, comprising a clamping surface and means for positioning a tool holder provided in the clamping surface, in that the means for positioning a tool holder are embodied as at least one conical element (conical bore, conical pin). At least one conical bore extends orthogonally to the clamping surface and/or at least one conical pin extends parallel to the receiving bore. Accordingly, the means for positioning a tool holder are embodied as at least one conical bore and/or at least one conical pin, wherein the longitudinal axes of the conical bores and/or the conical pins extend orthogonally to the clamping surface.

In accordance with the present invention, the clamping surface of the tool support according to the invention is provided with at least one conical element in the form of a conical bore or a conical pin. The conical bore as well as the positioning bores into which the conical pin or a conical sleeve provided with the conical bore can be pressed are producible within one mounting together with the machining step for producing the clamping surface and, if existing, a receiving bore. For example, after inside-diameter turning the receiving bore, the conical bore or the positioning bores can be produced also by inside-diameter turning in the same mounting of the tool support. In this way, the positioning bores and the conical bores can be positioned within the clamping surface as precisely as enabled by the manufacturing precision of the machine tool on which the tool support is machined. For high-performance machine tools the achievable positioning precision is better than 0.005 mm (5 μm). This precision is then also imparted to the tool support according to the invention and the tool holder according to the invention. Despite this high precision the manufacturing costs are relatively minimal because the tool support must not be repositioned and clamped anew but in one mounting the clamping surface and optionally the receiving bore as well as the conical bores and the positioning bores can be machined. This is possible with modem drilling tools or spindle-mounted tools in a very short period of time and therefore possible with relatively minimal costs.

In order for the tool support according to the present invention to be compatible with the tool holders according to DIN ISO 10889-1, in an advantageous embodiment of the present invention the receiving bore of the tool support can be produced in accordance with the aforementioned standard within the clamping surface. Also, this receiving bore can be produced in one mounting together with the conical bores and positioning bores according to the present invention so that also in this case a high precision and simultaneously also minimal manufacturing costs can be achieved.

The aforementioned object is solved according to the present invention for a tool holder for holding machining tools, the tool holder comprising a contact surface wherein in the contact surface means for positioning the tool holder in a tool support are provided in that the means for positioning of the tool holder are embodied as at least one conical element (conical bore, conical pin). At least one conical bore extends orthogonally relative to the contact surface and/or at least one conical pin extends orthogonally relative to the contact surface.

A conical bore in the tool support and a conical pin on the tool holder provide a positive-locking and very precise positioning of the tool holder relative to the receiving bore in the tool support. It is immediately apparent that for the positioning precision it is not important whether the conical bore is provided in the tool support and a matching conical pin is provided on the tool holder and projects past the contact surface of the tool holder or whether the conical pin is provided on the tool support and, in a complementary arrangement, a matching conical bore is provided in the tool holder. This does not change anything in regard to the claimed principle of positioning of the tool holder relative to the tool support in accordance with the present invention.

It is therefore in principle possible to arrange the conical pin and the conical sleeve either on the tool support or the tool holder. In this way, additional flexibility of the system according to the present invention comprising the tool support and the tool holder is provided relative to other requirements such as, for example, accessibility, available space and other considerations. Since DIN ISO 10889-1 provides for a flat clamping surface on the tool support, in general the conical bores and not the conical pins will be arranged in the tool support when it is desired to employ on the tool support according to the invention also tool holders that are configured in accordance with DIN ISO 10889-1 in addition to the tool holders configured according to the present invention.

Since according to the present invention positioning is realized with a conical bore and a complementary conical pin, the tolerances in producing the conical bore or the conical pin are relatively uncritical in the axial direction because these tolerances have only a very small effect on the positioning precision of the tool support as a result of the small conical angle of approximately 5 degrees to 40 degrees.

The tool holder according to the present invention may moreover have a cylindrical shaft and through bores for fastening screws.

In a further advantageous embodiment of the present invention, it is provided that the conical bore is part of a conical sleeve with cylindrical outer contour, that in the clamping surface of the tool support and/or in the contact surface of the tool holder cylindrical positioning bores are formed, and in that the conical sleeves or the conical pins are inserted or pressed in and glued into the positioning bores. These positioning bores can be embodied as simple cylindrical bores and can be produced very inexpensively but still with high precision. The conical sleeves and conical pins can then be produced, for example, of hardened steel and by means of a grinding process following the hardening step can be very precisely but still inexpensively produced from a very high quality material. After their production, the conical sleeves and/or the conical pins are pressed into the positioning bores, be it in the tool holder or in the tool support, and are fixed therein, for example, by a high-strength adhesive.

Moreover, it is provided according to the present invention that the conical sleeve does not project past the clamping surface of the tool support or the contact surface of the tool holder. In this case, the clamping surface of the tool support and the contact surface of the tool holder are still compatible with conventional tool holder interfaces that are commercially available.

When, as is particularly advantageous, the conical sleeves have an inner thread adjoining the conical bore, it is possible to align the conical sleeve in axial direction in the positioning bore and/or to secure it therein.

In this way, it is possible to press the conical sleeve somewhat deeper than the end position into the positioning bore and to subsequently screw into the thread of the conical sleeve a threaded pin until it is supported at the bottom of the positioning bore. When the threaded pin is now carefully further screwed in, the threaded pin will force the conical sleeve slowly into the desired end position. In this way, a very precise and still simple positioning of the conical sleeve in the positioning bore is possible which has a positive effect on the precision of the entire system. When the threaded pin remains within the conical sleeve and is secured by means of a screw retention, the conical sleeve is additionally secured against accidental displacement in the positioning bore.

In this way, with simple means a very high precision in regard to positioning of the conical sleeve in axial direction is achieved. This positioning of the conical sleeve can be easily carried out by unskilled personnel and leads to a further improvement of the positioning precision of the system according to the present invention comprising a tool support and a tool holder.

Moreover, advantageously it may be provided that the conical sleeve in axial and/or radial direction is elastic so that the positive-locking connection between conical pin and conical sleeve can be realized with a certain pretension and, by means of the elasticity of the conical sleeve, the pretension is delimited to a certain level. Also, small tolerances can be compensated in this way and, accordingly, a further improved precision is achievable.

Further advantages and advantageous embodiments of the invention can be taken from the attached drawing, its description, and the claims. All features disclosed in the drawing, the description, and the claims may be important for realizing the present invention alone as well as in any suitable combination with one another.

### BRIEF DESCRIPTION OF THE DRAWING

FIG. 1a shows a first embodiment of a VDI revolver according to the present invention with conical fixation with driven tool in an angled embodiment showing the tool support and the tool holder in an exploded view.

FIG. 1b shows a second embodiment of a BMT revolver (BMT=built-in motor turret) according to the present invention with conical fixation and drilling tool holder in angled arrangement in an exploded view.

FIG. 2 is an isometric view of an embodiment of a tool holder according to the present invention, wherein FIGS. 2a and 2b show detail views of the conical pins.

FIG. 3 is an isometric view of a tool support corresponding to the tool holder of FIG. 2.

FIGS. 4a to 4d show different views of the tool support according to the invention with inserted tool holder.

FIG. 5 is a longitudinal section along the line V-V of FIG. 4b.

FIGS. 6a to 6c show different views of a further embodiment of a tool support according to the present invention with inserted tool holder.

FIGS. 7a to 7c show different views of a further embodiment of the tool support according to the present invention with inserted tool holder.

FIGS. 8a to 8j show various embodiments of conical sleeves.

FIGS. 9a to 9j show various embodiments of conical pins.

FIGS. 10a to 10d show the interaction of various embodiments of conical sleeves and conical pins.

### DESCRIPTION OF THE PREFERRED EMBODIMENTS

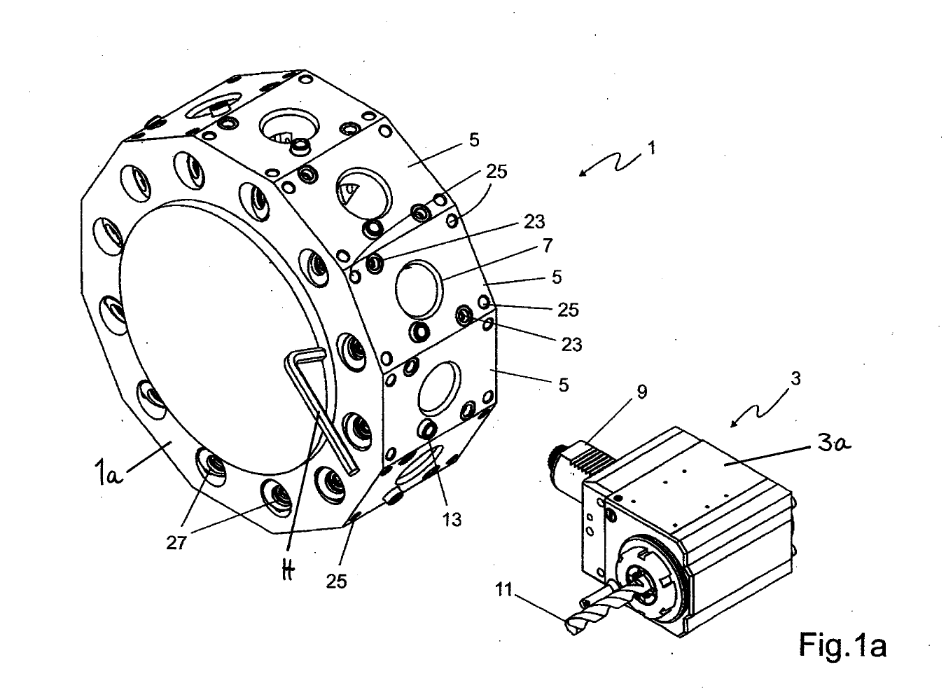

FIG. 1a shows a first embodiment of a tool support 1 according to the present invention as well as a corresponding tool holder 3 according to the present invention in an angled embodiment illustrated in isometric view. In addition to the tool holders 3 according to the present invention the tool support 1 can also receive conventional tool holders (not illustrated) according to DIN ISO 10889-1. The tool support 1 is embodied as a so-called revolver and has a support member 1a provided at its outer circumference with a multitude of flat clamping surfaces 5. Approximately at the center of the clamping surfaces 5 a receiving bore 7 is provided that serves for receiving a cylindrical shaft 9 of the tool holder 3.

The tool holder 3 in the illustrated embodiment is provided with a spiral drill bit 11 and is inserted with the cylindrical shaft 9 into the receiving bore 7 of the tool support 1. By means of the cylindrical shaft 9 also the drive action of the spiral drill bit 11 is realized as is known in the art. Based on this constellation it is especially apparent how important the precise and reproducible positioning of the tool holder 3 in the tool support 1 is in order to achieve a continuously high manufacturing quality. Moreover, it is apparent that the advancing force is introduced parallel to and displaced relative to the clamping surface 5 into the tool holder 3 and is transmitted by the latter by means of the interface according to the present invention into the tool support 1.

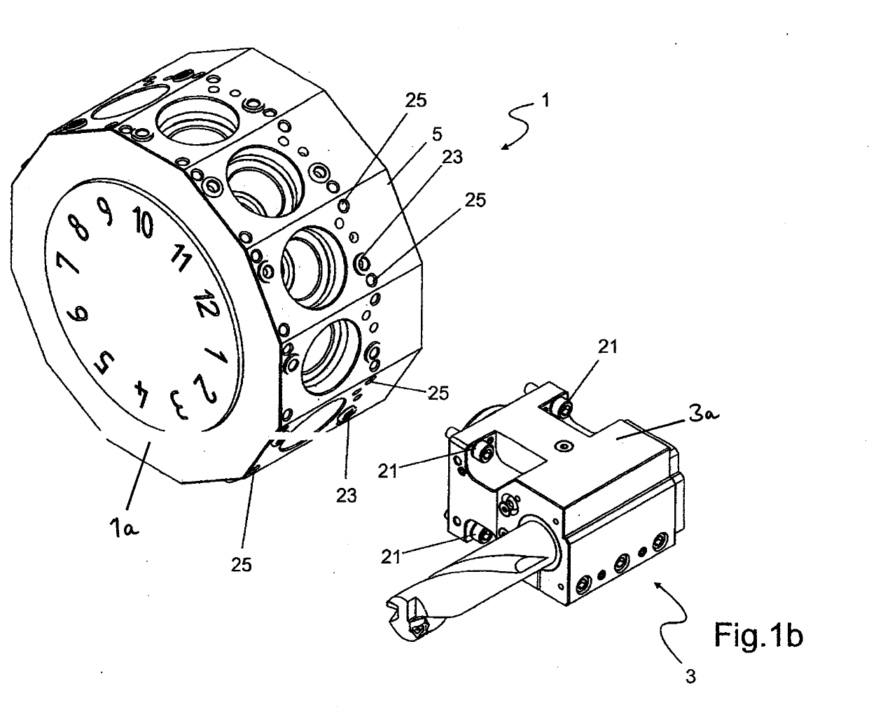

In order to attach the tool holder 3 with tool holder body 3a to the tool support 1, screws are provided whose screw heads 27 are visible on the left end face of the tool support 1 in FIG. 1a. The screws actuate a clamping device that is acting on the cylindrical shaft 9 of the tool holder 3. The clamping devices are actuated by means of a hexagon spanner H insertable into the screw heads 27. For clamping the tool holder 3 in the tool support 1 a toothing 15 (see FIG. 2) is formed on the cylinder shaft 9 in accordance with DIN ISO 10889-1.

In the clamping surface 5 in addition to the receiving bore 7 also a connection 13 for a cooling lubricant is provided that serves for supplying the cooling lubricant to the tool holder 3 and to the tool that is clamped in the tool holder 3.

In addition to the flat clamping surface 5, the receiving bore 7 and the cylindrical shaft 9 (all known from DIN ISO 10889-1), the revolver illustrated in FIG. 1a also is provided with conical elements in the form of conical bores 23 and inner threads 25 according to the present invention.

The conical elements in the form of conical bores 23 interact according to the present invention with conical elements in the form of conical pins (not illustrated in FIG. 1a) of the tool holder 3 and effect a precise and reproducible positioning of the tool holder 3.

In FIG. 1b a second embodiment of a BMT revolver 1 is illustrated that has been improved upon in accordance with the present invention. The tool holder 3 with tool holder body 3a is attached in this embodiment by means of (preferably four) fastening screws 21 screwed into the (preferably four) inner threads 25 to the revolver 1. Positioning is also realized in this embodiment by means of conical sleeves 23 and conical pins, not illustrated.

An important term for describing the quality of the interface between the tool support 1 and the tool holder 3 is the repeat accuracy for multiple insertions of a tool holder 3 into the tool support 1. The VDI interface according to DIN ISO 10889-1 achieves a repeat accuracy of approximately 0.05 mm which for many workpieces, primarily high-quality workpieces, is not sufficient and requires a time-consuming and thus expensive compensation in the control unit of the corresponding machine tool.

In FIG. 2 the tool holder 3 according to the invention illustrated in FIG. 1a is now illustrated such that the cylindrical shaft 9 that is a component of DIN ISO 10889-1 can be seen well together with its toothing 15. Moreover, the contact surface 17 of the tool holder 3 is shown clearly.

The contact surface 17 of the tool holder 3 when the tool holder 3 is inserted rests against the clamping surface 5 of the tool support 1 and the cylindrical shaft 9 is received in the receiving bore 7. According to the present invention, it is provided that two conical pins 19.1 and 19.2 project from the contact surface 17.

The truncated cone section of the conical pin 19.1 that is shown in FIG. 2a is of complete rotational symmetry while the truncated cone section of conical pin 19.2 shown in FIG. 2b is flattened on two opposed sides (conical blade pin) so that a positive locking action with the conical bore 23 provided in the tool support 1 is realized only at the areas of the conical pin 19.2 that are not flattened. The conical blade pin 19.2 is mounted such that the non-flattened areas of the conical pin 19.2 are arranged orthogonally to a connecting line between the conical pins 19.1 and 19.2. However, it is also possible to provide two conical pins 19.1 and 19.2 that have complete rotational symmetry.

Aside form the conical pins 19, in FIG. 2 also the fastening screws 21 are visible that project with their thread past the contact surface 17.

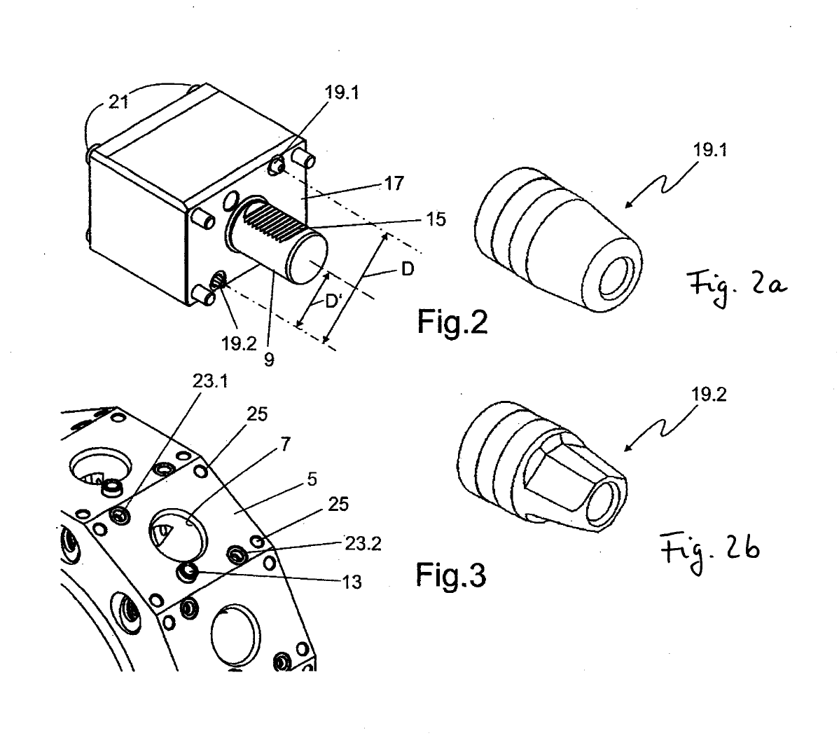

In FIG. 3, the tool support 1 of FIG. 1a is illustrated again that is compatible with the tool holder 3 according to FIG. 2. In the clamping surface 5 two conical bores 23.1 and 23.2 are formed that interact with the conical pins 19.1 and 19.2 of the tool holder 3. The spacing of the (preferably four) inner threads 25 in the tool support 1 correspond to the spacing of the fastening screws 21 (see FIG. 2).

When the tool holder 3 is now inserted with its cylindrical shaft 9 into the receiving bore 7 of the tool holder 1, the conical pins 19.1 and 19.2 move into the conical bores 23.1 and 23.2 of the tool support 1 and form a positive-locking connection. Subsequently, the four fastening screws 21 are screwed into the inner threads 25 and in this way a fixed connection between the tool holder 3 and the tool support 1 is produced. Clamping or fixation of the tool holder 3 by means of the toothing 15 provided on the cylindrical shaft 9, as is provided for in accordance with DIN ISO 10889-1, is then no longer required because the four fastening screws in combination with the positive-locking connection according to the present invention between conical pins 19 and conical bores 23 represents a highly loadable and precise connection of tool support 1 and tool holder 3.

There is the possibility of attaching the tool holder 3 on the tool support 1 either only by means of the fastening screws 21, only by means of the cylindrical shaft 9 or jointly by means of the fastening screws 21 and the cylindrical shaft 9.

The conical pins 19.1 and 19.2 have a relatively large spacing D. This large spacing D contributes primarily to the very high positioning precision and excellent repeat accuracy when the tool holder 3 is placed onto the tool support 1. At the same time, also greater torque between tool support 1 and tool holder 3 can be transmitted. Therefore, generally the spacing D will be selected as large as possible. The cylindrical shaft 9 in this embodiment provides only the drive action for the tool 11.

When the cylindrical shaft 9 and the receiving bore 7 are used for positioning the tool holder 3, it is sufficient when one conical bore 23 and one conical pin 19 are provided. In this case, between the cylindrical shaft 9 and the conical pin 19 only the spacing D′ is effective so that the repeat accuracy is not as great as if positioning were realized by means of two conical bores 23 and two conical pins 19.

The means for positioning the tool holder 3 relative to the tool support 1 in accordance with the present invention are advantageous because of their minimal manufacturing costs since a conical pin 19 as well as a conical bore 23 can be produced very simply and inexpensively with high precision. Such a conical pin, for example, can be produced of hardened steel. After hardening, the functional surfaces, for example, a cylindrical section (not visible in FIG. 2) and the truncated cone shaped section of the conical pins 19 can be produced by grinding not only inexpensively but also with very high precision and exactness. The same holds true also for the conical bore 23 when it is produced advantageously in the sleeve body of a conical sleeve provided as a separate component wherein the sleeve body of the conical sleeve then also has a cylindrical section and in the interior the conical bore 23 is embodied concentrically to the cylindrical section.

Since the conical pins 19 and the conical bores 23 have a relatively small cone angle, the tolerances or dimensional deviations in axial direction are relatively uncritical and have an effect only to a minimal extent on the positioning precision of the tool holder 3. A further important advantage of positioning of the tool holder 3 relative to the tool support 1 according to the present invention is to be seen in that the conical pins 19 as well as the conical sleeves 31 can be pressed into cylindrical positioning bores (without reference numeral in FIGS. 2 and 3) and these positioning bores can be produced with one mounting with the clamping surface 5 of the tool support 1 or the contact surface 17 of the tool holder 3. In that this can be done with one mounting, the limiting factor for positioning precision of the bores is the machining precision of the machine tool on which the tool support 1 or the tool holder 3 is manufactured. High-performance machining centers achieve a machining precision of 5/1000 mm (5 μm) wherein this precision is satisfactory for almost any application. Because of the possibility of producing the positioning bores in one mounting together with the clamping surface 5 or the contact surface 17 and the receiving bore 7, this precision can be achieved very inexpensively in mass production when introducing the positioning bores. As a result, the positioning precision of the tool holder 3 according to the present invention can be improved in this way by an order of magnitude relative to the VDI interface according to DIN ISO 10889-1: Instead of a repeat accuracy or positioning precision of 0.05 millimeters in case of the VDI interface, with the system according to the present invention, despite only minimal additional costs, a positioning precision or repeat accuracy of 0.005 mm (5 μm) is achieved.

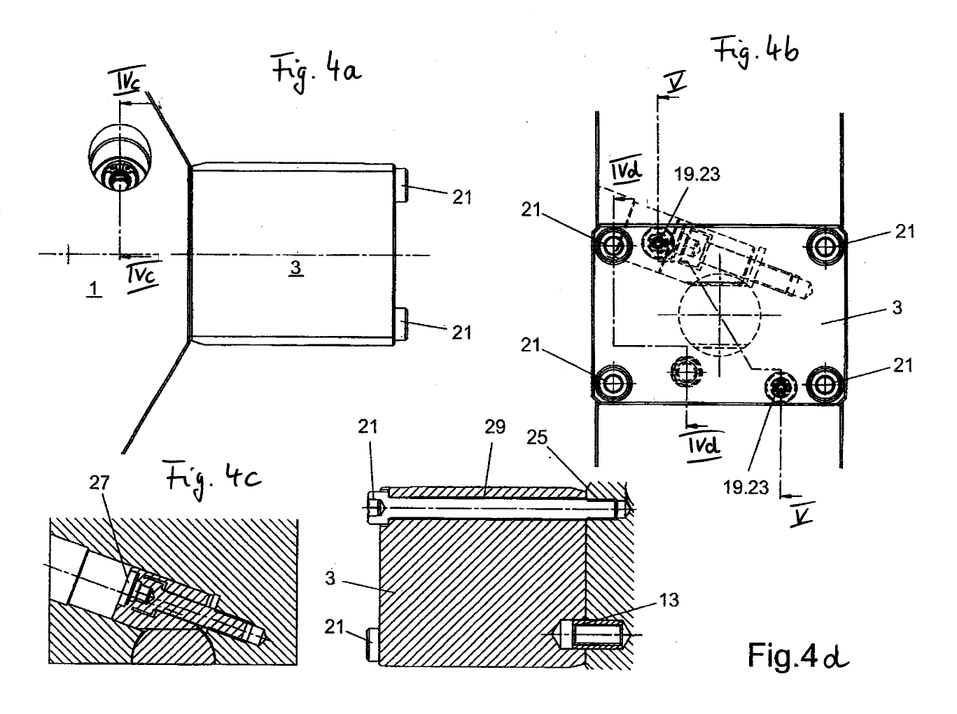

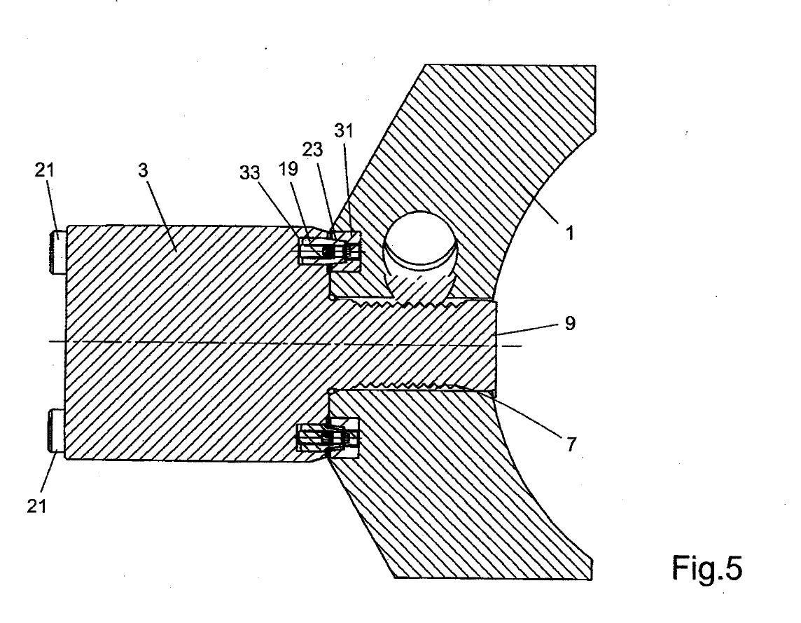

In FIGS. 4a to 4d and FIG. 5 various views and sections of the tool support 1 with inserted tool holder 3 are illustrated. In the side view of the tool holder 3 according to FIG. 4a as well as the end view of the tool holder according to FIG. 4b it is shown that the fastening screws 21 are positioned relatively far outwardly on the tool holder 3 so that for a given clamping force an excellent fixation of the tool holder 3 on the tool support 1 is effected. In the section view according to FIG. 4c along section line IVc-IVc of FIG. 4a the screw head 27 of the clamping mechanism according to FIG. 1 can be seen.

In the right upper illustration FIG. 4b an end view of the tool holder 3 mounted on the tool support 1 is illustrated. The dashed lines indicate the receiving bore 7 and the cylindrical shaft 9. Moreover, the positive-locking connection in accordance with the present invention of the conical pin 19 and the conical bore 23 are also illustrated by dashed lines. In this illustration, the spacing D between the positioning means 19 and 23 can be seen well.

In the right lower illustration FIG. 4d a section view along the section line IVd-IVd of FIG. 4b is illustrated. In this section view the through bores 29 for the fastening screws 21 and the inner threads 25 in the tool support 1 can be seen.

FIG. 5 shows a section view of along the section line V-V of FIG. 4b. In this section view the conical bore 23 is part of a conical sleeve 31 wherein the conical sleeve 31 is pressed into a positioning bore 33 provided in the tool support 1.

In a corresponding manner, the conical pin 19 is pressed into a positioning bore 33 in the tool holder 3. The conical sleeve 31 as well as the conical pin 19 in the embodiment illustrated in FIG. 5 are produced by trepanning and each have an inner thread (no reference numeral). In this way, it is possible, for example, to adjust and/or fasten the conical sleeve 31 in the positioning bore 33 in axial direction by screwing in a screw. The same holds true also for the conical pin 19. Here it is also possible to press the conical pin with a cylindrical section into the corresponding positioning bore 33 and to bring it into the desired position in axial direction by means of a clamping screw and a suitable gauge so that the truncated cone section of the conical pin is either positioned free of play, with a light pretension or with a defined play of only a few hundredths of a millimeter in the conical bore of the conical sleeve 31 when the tool holder 3 by means of the screws 21 is attached on the tool support 1.

In the lower part of FIG. 5 a further conical pin and a further conical sleeve are illustrated. For reasons of simplicity, in the lower portion no reference numerals are used. Conical pin and conical sleeve in the upper part of FIG. 5 as well as in the lower part of FIG. 5 are of identical configuration.

It is understood that, if needed, it is also possible, of course, to arrange the conical sleeve 31 in a positioning bore 33 of the tool holder 3 and to arranged correspondingly the conical pin 19 in a positioning bore 33 of the tool support 1. This is a reversal that may be useful in individual situations. The advantages of the solution according to the invention are provided entirely in both variants.

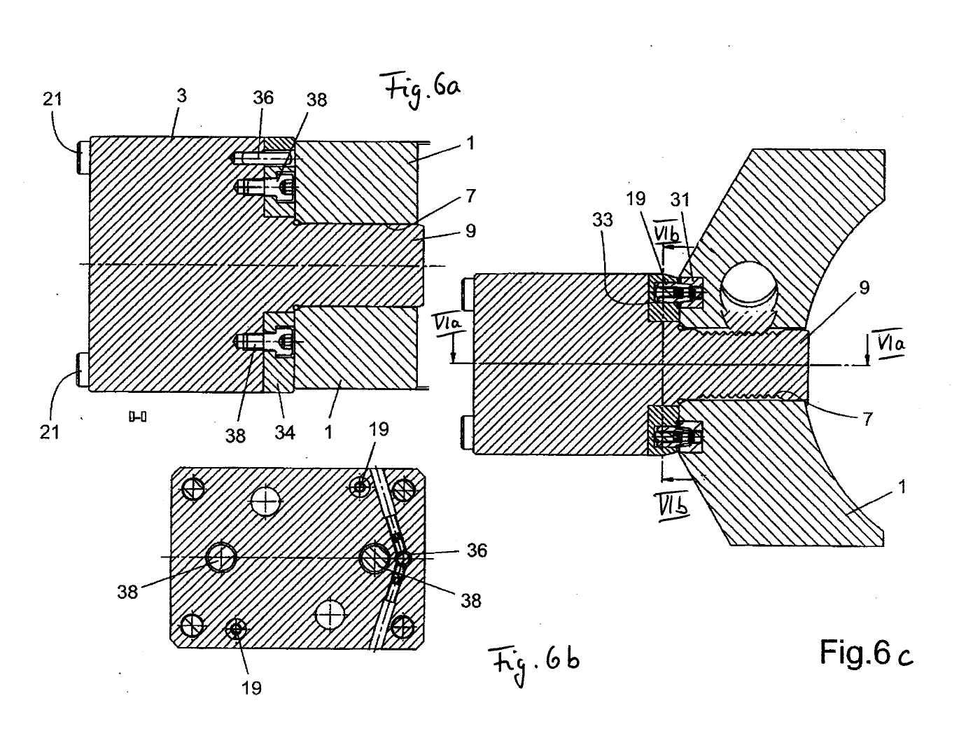

In FIGS. 6a to 6c, a further embodiment is illustrated in which the conical pins 19 are attached to an alignment plate 34. FIG. 6a shows a section along section line VIa-VIa of FIG. 6c; FIG. 6b shows a section along section line VIb-VIb of FIG. 6c. The alignment plate 34 is connected by pins to the tool holder 3 and screwed on (see reference numerals 36 and 38). Before the pin connection is established, the alignment plate 34 can be aligned relative to the tool holder 3 such that a still further improved positioning precision is achieved. This will be done when a machining step to be performed with this tool holder 3 is supposed to fulfill the highest requirements with regard to precision. The other tool holders 3 that are also participating in machining a workpiece can be embodied without alignment plate 34. In the configuration illustrated in FIG. 6 the tool support 1 has no alignment plate.

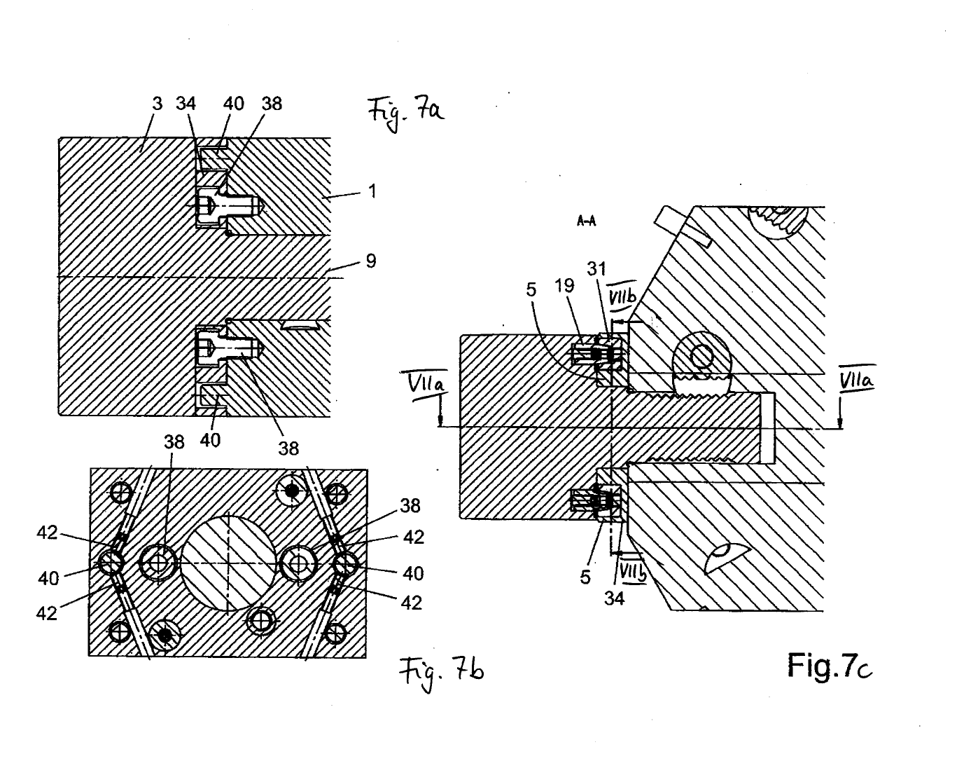

In FIGS. 7a to 7c, a further embodiment is illustrated in which the conical sleeves 31 are attached to an alignment plate 34. FIG. 7a shows a section along section line VIIa-VIIa; FIG. 7b shows a section along section line VIIb-VIIb. The alignment plate 34, in turn, is connected to the tool support 1 by pins 40 and screws 38. The alignment of the alignment plate 34 riveted to the tool support 3 is realized by threaded pins 42 that act on the pins 40 of the tool support 1. The other clamping surfaces 5 of the revolver 1 can be embodied without alignment plate 34.

Of course, it is also possible to furnish the tool holder 3 as well as the tool support 1 with an alignment plate 34.

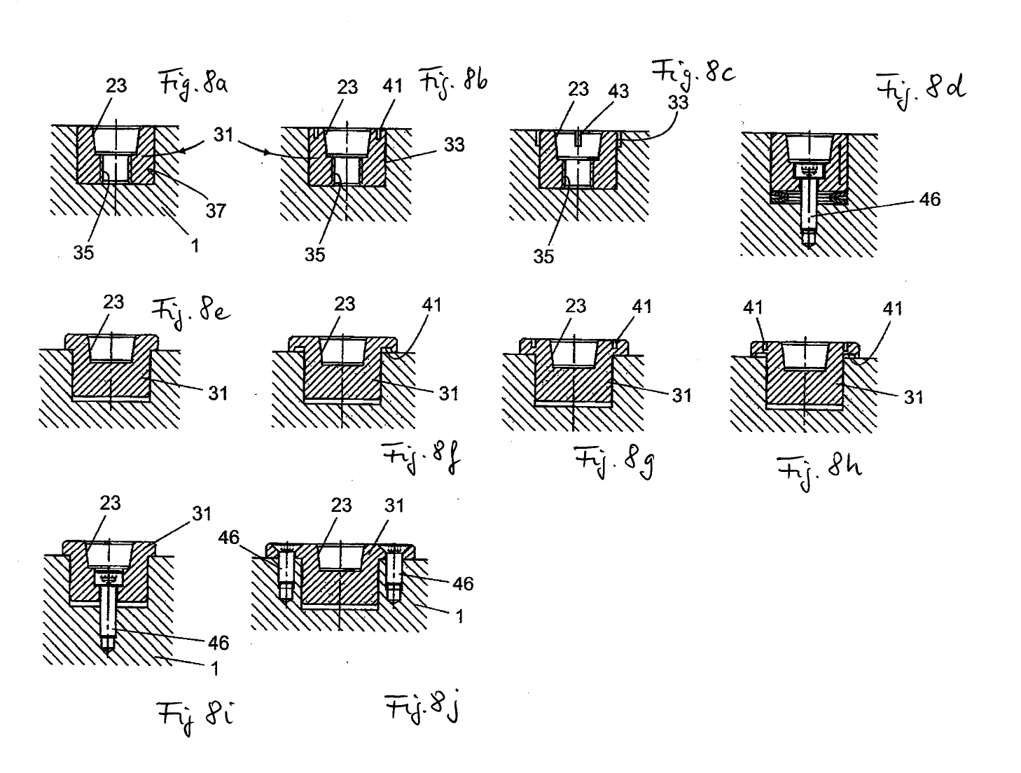

In FIG. 8 various embodiments of conical sleeves 31 according to the present invention are shown in section view. The simplest embodiment is illustrated in FIG. 8a. The conical sleeve 31 has a sleeve body in the form of cylindrical section 37 with cylindrical contour at its outer periphery and provided with a conical bore 23 and an adjoining inner thread 35. The outer diameter of the cylindrical section 37 is matched to the diameter of the positioning bores 33 such that a pressfit between the conical sleeve 31 and the positioning bore 33 results.

By means of the inner thread 35 it is possible to very sensitively and precisely adjust the conical sleeve 31 in the positioning bore 33 in axial direction when it has been pressed into the positioning bore 33. At the same time, a threaded pin (not illustrated) that has been screwed into the inner thread 35 prevents the conical sleeve 31 from being accidentally pressed downwardly into the positioning bore 33.

In FIG. 8b an embodiment of a conical sleeve 31 is illustrated in which on an end face 39 an annular groove 41 is provided. In this way a certain flexibility and elasticity of the conical bore 23 in radial direction is provided so that smallest deviations with respect to the spacing D between the two conical pins 19 (see FIG. 2) and the correlated conical bores 23 (see FIG. 3) can be compensated. A similar effect can be achieved when the conical sleeve 31 has a radial groove 43 and the positioning bore 33 is of a stepped configuration (FIG. 8c).

In FIG. 8d an embodiment of the conical sleeve 31 according to the present invention is illustrated in which below the conical sleeve 31 at the bottom (without reference numeral) of the positioning bore 33 two plate springs 45 are arranged that enable movement of the conical sleeve 31 in axial direction. In this case, the cylindrical section 37 of the conical sleeve 31 and the positioning bore 33 are embodied as a sliding seat and the conical sleeve 31 is fixed by a screw (46).

In FIGS. 8e to 8h embodiments of the conical sleeves according to the present invention are illustrated where the conical sleeve 31 has a flange 47, respectively. The flange 47 ensures that the position of the conical sleeve 31 relative to the clamping surface 5 or the contact surface 17, for example, is defined unequivocally when the flange 47 rests against the clamping surface 5 or the contact surface 17. In this way, it is not necessary to provide an inner thread and it is sufficient to embody a conical bore 23 to be coaxial to the cylindrical section 37 of the conical sleeve 31.

In the embodiments according to FIGS. 8f, 8g, and 8h, different annular grooves 41 are formed in the flange 47 that provide elasticity in axial and/or radial direction of the conical bore 23 relative to the clamping surface 5 or the contact surface 17 in axial direction. Simultaneously or alternatively, also a certain radial flexibility of the conical bore 23 relative to the positioning bore 33 can be achieved.

It is understood that the illustrated embodiments have only exemplary character and that it is possible to achieve the partially desired elasticity in axial and/or radial direction also by other shapes and configurations.

In the embodiments according to FIGS. 8i and 8j the conical sleeves 31 are screwed to the tool support 1.

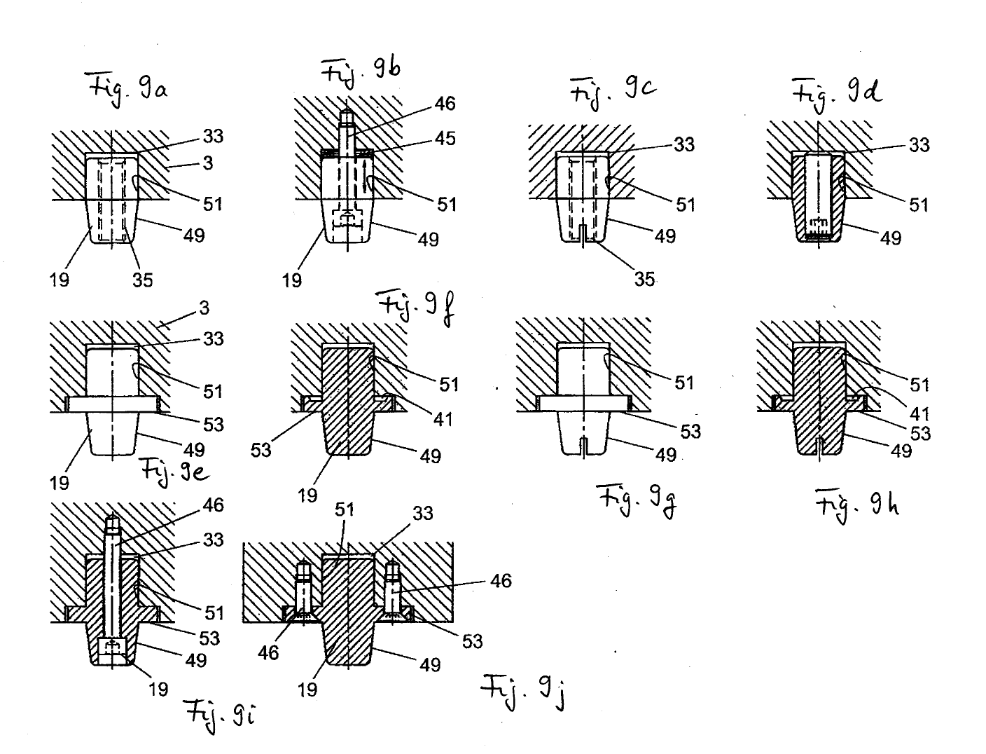

FIGS. 9a to 9j show various embodiments of conical pins 19. All embodiments have in common that the conical pins 19 have a truncated cone section 49 as well as a cylindrical section 51 with cylindrical outer contour. With the cylindrical section 51 the conical pin 19 is pressed into a positioning bore 33 of the tool holder 3 or of the tool support 1. Similarly to the procedure in connection with the conical sleeves 31, the conical pins 19 may also be adhesively connected to the positioning bore 33 as soon as it has reached the desired position in axial direction.

Also positioning of the conical pins 19 in axial direction is relatively easily possible in that a pressing device (not illustrated) is used that has a conical bore that interacts with the truncated cone section 49 of the conical pin 19. It is now possible to design the pressing device such that the conical pin 19 has reached its correct position in axial direction when the pressing device rests against the contact surface 17 of the tool holder 3. The same holds true relative to the clamping surface 5 when the conical pin 19 is to be pressed into a positioning bore 33 of the tool support 1.

In the embodiments according to FIGS. 9e to 9j, the conical pin 19 has a collar 53 that may be made “softer” by means of an annular groove 41 in axial direction (see FIGS. 9f and 9h) so that the conical pin 19 in axial direction is slightly elastic. In this way, it is possible to compensate possibly occurring deviations in various tool holders or conical sleeves 31 in that the conical pin 19 can be slightly displaced or moved in the positioning bore in axial direction.

The embodiment according to FIG. 9b has many common features with the conical sleeve 31 illustrated and described in connection with FIG. 8d.

In the embodiments according to FIGS. 9c, 9g, and 9h, in the truncated cone section 49 at least one radial groove 43 is formed that effects a radial elasticity of the truncated cone section 49 of the conical pin 19. Of course, it is also possible to provide, for example, two radial grooves 43 at an angle of 90 degrees relative to one another. In this way, the truncated cone section 49 would be essentially radially slotted and would become significantly more elastic in radial direction.

The attachment of the conical pin 19 in FIGS. 9i and 9j corresponds to that of conical sleeves 31 in FIGS. 8i and 8j so that reference is being had to the description provided for these Figures.

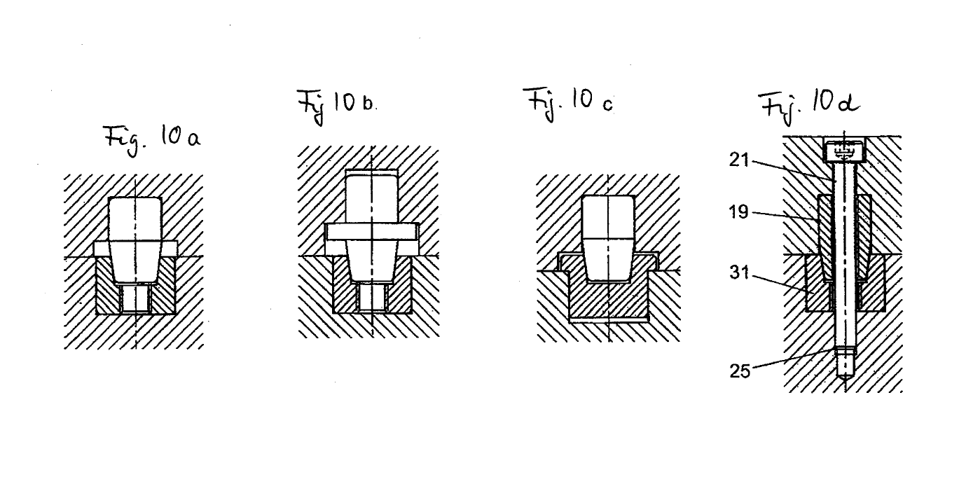

FIG. 10a shows the interaction of a conical sleeve 31 according to FIG. 8a and a conical pin 19 according to FIG. 9a.

FIG. 10b shows the interaction of a conical sleeve 31 according to FIG. 8a and a conical pin 19 according to FIG. 9e.

FIG. 10c shows the interaction of conical sleeve 31 according to FIG. 8e and a conical pin 19 according to FIG. 9a.

In the embodiment according to FIG. 10d the fastening screw 21 passes through the conical sleeve 31 and the conical pin 19.

The specification incorporates by reference the entire disclosure of German priority document 10 2009 037 167.2 having a filing date of Aug. 3, 2009.

While specific embodiments of the invention have been shown and described in detail to illustrate the inventive principles, it will be understood that the invention may be embodied otherwise without departing from such principles.

What is claimed is:

1. A tool support for a machine tool, the tool support comprising:
a clamping surface;
means for positioning a tool holder, wherein said means for positioning are provided at said clamping surface;
wherein said means for positioning comprise at least one conical element wherein a longitudinal axis of said at least one conical element extends orthogonally to said clamping surface;
wherein said at least one conical element is selected from the group consisting of a conical bore or a conical pin.

2. The tool support according to claim 1, wherein said clamping surface comprises a receiving bore that has a longitudinal axis orthogonal to said clamping surface.

3. The tool support according to claim 1, wherein said clamping surface comprises several inner threads.

4. The tool support according to claim 1, comprising a conical sleeve in which said conical bore is disposed, wherein said conical sleeve has a substantially cylindrical outer contour, wherein said clamping surface has at least one cylindrical positioning bore, wherein said conical sleeve is inserted into said at least one positioning bore.

5. The tool support according to claim 4, wherein said conical sleeve does not project past said clamping surface.

6. The tool support according to claim 5, further comprising an alignment plate, wherein said conical sleeve or said conical pin are arranged in said alignment plate.

7. The tool support according to claim 1, wherein said clamping surface has at least one cylindrical positioning bore and wherein said conical pin is inserted into said at least one positioning bore.

8. A tool holder for a tool, the tool holder comprising;
a tool holder body comprising a contact surface;
means for positioning the tool holder on a tool support;
wherein said means for positioning comprises at least one conical element arranged orthogonally to said contact surface;
wherein said at least one conical element is selected from the group consisting of a conical bore or a conical pin.

9. The tool holder according to claim 8, comprising a cylindrical shaft that projects from said contact surface, wherein a longitudinal axis of said cylindrical shaft extends orthogonally to said contact surface.

10. The tool holder according to claim 8, comprising through bores that are disposed in said contact surface such that said through bores are aligned with inner threads provided in a clamping surface of the tool support.

11. The tool holder according to claim 8, comprising a conical sleeve in which said conical bore is disposed, wherein said conical sleeve has a substantially cylindrical outer contour, wherein said contact surface has at least one cylindrical positioning bore, wherein said conical sleeve or said conical pin is inserted into said at least one positioning bore.

12. The tool holder according to claim 11, wherein said conical sleeve does not project past said contact surface.

13. The tool holder according to claim 11, comprising an alignment plate attached to said tool holder body, wherein said conical sleeve or said conical pin are arranged in said alignment plate.

14. The tool holder according to claim 8, compatible with DIN ISO 10889.

15. The tool holder according to claim 8, wherein said contact surface has at least one cylindrical positioning bore, wherein said conical pin is inserted into said at least one positioning bore.

16. A conical sleeve for a tool support or a tool holder, the conical sleeve comprising:
a sleeve body provided with a substantially cylindrical outer contour;
a conical bore disposed in said sleeve body;
an inner thread disposed in said sleeve body;
wherein the sleeve body is adapted to be inserted into a positioning bore of a clamping surface of the tool support or a positioning bore of a contact surface of the tool holder.

17. The conical sleeve according to claim 16, comprising a flange disposed on an end face of said sleeve body.

18. The conical sleeve according to claim 16, embodied to be elastic in axial direction and/or radial direction.

19. The conical sleeve according to claim 18, comprising an annular groove disposed in an end face of the conical sleeve.

20. The conical sleeve according to claim 18, comprising radial grooves at an end face of the conical sleeve.

21. The conical sleeve according to claim 18, comprising a flange disposed on an end face of said sleeve body, wherein said flange is provided with an annular groove or radial grooves.

22. A conical pin for a tool support or a tool holder, wherein the conical pin comprises:
a cylindrical section adapted to be inserted into a positioning bore of a clamping surface of the tool support or a positioning bore of a contact surface of the tool holder;
a truncated cone section adjoining said cylindrical section.

23. The conical pin according to claim 22, comprising a collar.

24. The conical pin according to claim 22, embodied to be elastic in axial direction and/or radial direction.

25. The conical pin according to claim 24, wherein said truncated cone section has at least one radial groove.

26. The conical pin according to claim 24, comprising a collar provided with an annular groove.
